(19) United States
(12) Patent Application Publication
(10) Pub. No.: US 2025/0377250 A1
(43) Pub. Date: Dec. 11, 2025

(54) Residual Stress Detection Method and residual stress detection system

(71) Applicant: Advanced ACEBIOTEK Co., Ltd., Hsinchu County (TW)

(72) Inventors: Yung-Chou Hsu, New Taipei City (TW); Hui-Shun Kuan, Taipei City (TW); Chan-Shan Yang, Taipei City (TW); Ting Cheng, Taipei City (TW); Chi-En Hsieh, Tainan City (TW); Jyh-Chern Chen, New Taipei City (TW); Shen-Fu Hsu, Taitung County (TW)

(73) Assignee: Advanced ACEBIOTEK Co., Ltd., Hsinchu County (TW)

(21) Appl. No.: 18/822,274

(22) Filed: Sep. 1, 2024

(30) Foreign Application Priority Data
Jun. 7, 2024 (TW) 113121192

(51) Int. Cl. G01L 1/24

(52) U.S. Cl. CPC G01L 1/241

(57) ABSTRACT

A residual stress detection method includes generating a terahertz emission electromagnetic wave, and emitting the terahertz emission electromagnetic wave to a test specimen through a first polarizer; detecting, through a second polarizer, a plurality of terahertz reception electromagnetic waves reflected, transmitted or scattered after the terahertz emission electromagnetic wave is incident on the test specimen; measuring a plurality of characteristic signals according to the terahertz emission electromagnetic wave and the plurality of terahertz reception electromagnetic waves; analyzing the plurality of characteristic signals to determine a plurality of characteristics of the test specimen; and determining residual stress of the test specimen according to the plurality of characteristics.

### BACKGROUND OF THE INVENTION

### 1. Field of the Invention

The present invention relates to a residual stress detection method and residual stress detection system, and more particularly, to a residual stress detection method and residual stress detection system enabling non-contact and non-destructive detection for residual stress.

### 2. Description of the Prior Art

Residual stress refers to the stress that remains in a solid material even after the primary source of stress has been removed. There are several reasons or mechanisms that lead to the generation of residual stress, including non-elastic (plastic or mechanical) deformation, temperature gradients (due to temperature cycling), or structural changes (such as phase transitions), resulting in non-uniform deformation within the material. The presence of residual stress can impact the strength and other mechanical properties of a component and may lead to defects during its application, such as deformation and cracking. Ultimately, these defects can affect the component's condition, precision, and service life. For example, in the manufacturing process of wafers, various steps such as crystal growth, cutting, grinding, polishing, and doping can introduce surface or internal residual stress in the wafer. This can cause the wafer to warp or even fracture during subsequent processing.

Therefore, to ensure the quality of components, it is essential to timely detect and measure residual stress during the manufacturing process. Generally, the magnitude and direction of residual stress are calculated based on strain or equivalent displacement. Current measurement techniques fall into two categories: destructive and non-destructive methods. These methods can further be categorized based on measurement depth as surface residual stress and internal residual stress.

In the prior art, one common destructive method for measuring surface residual stress is the hole-drilling method. In this approach, holes are drilled on the surface of the test specimen, and strain or displacement measurements are used to determine residual stress based on the principles of elasticity. However, it is evident that the destructive residual stress measurement methods have limited applicability due to physical damages to the test specimen. In practice, measuring, analyzing, and predicting the internal residual stress state of a material is more critical than surface residual stress. Unfortunately, internal residual stress is often challenging to directly observe or measure. Non-destructive stress measurement techniques typically involve methods such as Raman spectroscopy, ultrasonic testing, and X-ray diffraction (XRD). However, these techniques can only measure surface or shallow-depth residual stress in the test specimen and cannot assess residual stress distribution deep within the material or the test specimen.

Therefore, developing effective non-destructive methods for detecting residual stress remains a significant goal in the industry.

### SUMMARY OF THE INVENTION

Therefore, the present invention is to provide a residual stress detection method and residual stress detection system to enable non-destructive detection for residual stress.

An embodiment of the present invention discloses a residual stress detection method, which comprises generating a terahertz emission electromagnetic wave, and emitting the terahertz emission electromagnetic wave to a test specimen through a first polarizer; detecting, through a second polarizer, a plurality of terahertz reception electromagnetic waves reflected, transmitted or scattered after the terahertz emission electromagnetic wave is incident on the test specimen; measuring a plurality of characteristic signals according to the terahertz emission electromagnetic wave and the plurality of terahertz reception electromagnetic waves; analyzing the plurality of characteristic signals to determine a plurality of characteristics of the test specimen; and determining residual stress of the test specimen according to the plurality of characteristics.

Another embodiment of the present invention discloses a residual stress detection system, which comprises a first polarizer, positioned in front of a test specimen; a second polarizer, positioned behind the test specimen; a terahertz electromagnetic wave generator, positioned in front of the first polarizer, configured to generate a terahertz emission electromagnetic wave, and emit the terahertz emission electromagnetic wave to a test specimen through the first polarizer; a terahertz electromagnetic wave receiver, positioned behind the second polarizer, configured to detect, through the second polarizer, a plurality of terahertz reception electromagnetic waves reflected, transmitted or scattered after the terahertz emission electromagnetic wave is incident on the test specimen; and a detection device, coupled to the terahertz electromagnetic wave generator and the terahertz electromagnetic wave receiver, configured to measure a plurality of characteristic signals according to the terahertz emission electromagnetic wave and the plurality of terahertz reception electromagnetic waves, analyze the plurality of characteristic signals to determine a plurality of characteristics of the test specimen, and determine residual stress of the test specimen according to the plurality of characteristics.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a functional block diagram of a residual stress detection system according to an embodiment of the present invention.

FIG. 2 and FIG. 3 are schematic diagrams of time-domain and frequency-domain optical spectra detected by the terahertz emission electromagnetic waves.

FIG. 4 and FIG. 5 are schematic diagrams of residual stress detection systems according to embodiments of the present invention.

FIG. 6A and FIG. 6B respectively illustrate C-Scan detection of a wafer by the residual stress detection system shown in FIG. 5.

FIG. 7 illustrates B-Scan detection of a wafer by the residual stress detection system shown in FIG. 5.

FIG. 8A and FIG. 8B are schematic diagrams of detecting the electric field and refractive index of a test specimen according to embodiments of the present invention.

FIG. 9 is a schematic diagram of phase detection for a test specimen according to an embodiment of the present invention.

FIG. 10 is a flowchart of a residual stress detection process according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

In order to effectively detect residual stress, especially within materials, the present invention utilizes terahertz electromagnetic waves for non-contact and non-destructive testing. Terahertz electromagnetic waves operate in the frequency range of 10¹¹ Hz to 10¹³ Hz (0.1 THz to 10 THz), allowing penetration through non-conductive materials and measurement of highly water-containing substances. The advantages of terahertz testing include its ability to penetrate various materials and structures within sheet materials. It can assess optical coefficients, electrical properties, layer thickness, and detect structural defects. Terahertz testing is also applicable in technical inspections during manufacturing processes, as well as for inspecting semi-finished or finished products. When using terahertz electromagnetic waves for material testing, their lower frequency compared to infrared electromagnetic waves (ranging from 10¹³ Hz to 10¹⁵ Hz) ensures minimal photon energy, preventing damage to molecular structures and maintaining material integrity. It does not exacerbate existing damage or defects, making it suitable for measuring high-polymer materials and crystalline structures.

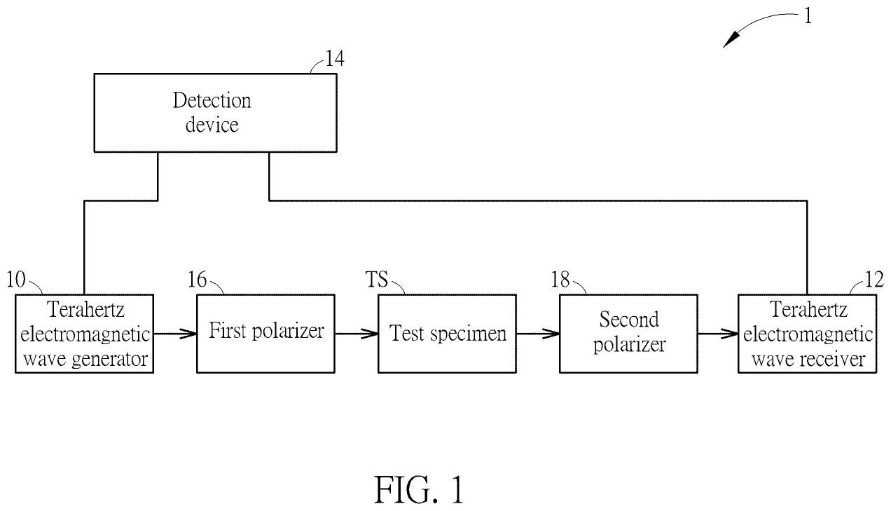

Specifically, please refer to FIG. 1. FIG. 1 illustrates a functional block diagram of a residual stress detection system 1 according to an embodiment of the present invention. The residual stress detection system 1 includes a terahertz electromagnetic wave generator 10, a terahertz electromagnetic wave receiver 12, a detection device 14, a first polarizer 16, and a second polarizer 18. The residual stress detection system 1 is designed to detect residual stresses in a test specimen TS. The terahertz electromagnetic wave generator 10 generates a terahertz emission electromagnetic wave, and emits the terahertz emission electromagnetic wave toward the test specimen TS via the first polarizer 16. The terahertz electromagnetic wave receiver 12 detects, via the second polarizer 18, a plurality of terahertz reception electromagnetic waves reflected, transmitted or scattered after the terahertz emission electromagnetic wave is incident on the test specimen TS. The detection device 14 is coupled to both the terahertz electromagnetic wave generator 10 and the terahertz electromagnetic wave receiver 12, and is configured to measure a plurality of characteristic signals based on the terahertz emission electromagnetic wave and the terahertz reception electromagnetic waves, and analyze thee characteristic signals to determine a plurality of characteristics of the test specimen TS, so as to determine the magnitude and distribution of residual stresses.

Specifically, the residual stress detection system 1 utilizes the first polarizer 16 and the second polarizer 18 to implement polarimetric measurement techniques, so as to measure the optical activity of the test specimen TS. The first polarizer 16 acts as a polarizer, converting the terahertz emission electromagnetic wave emitted by the terahertz electromagnetic wave generator 10 into linearly polarized or elliptically polarized electromagnetic waves. The second polarizer 18 serves as an analyzer, detecting the polarization state (linear or elliptical) of the terahertz reception electromagnetic waves. In fact, the polarizer can also be used as the analyzer. There is no substantial difference between the polarizer and the analyzer, except that they are placed in different positions to serve different purposes, and they are completely interchangeable. According to Malus's Law, the angle between the transmission axes of the polarizer and the analyzer can be used to calculate the transmitted irradiance. Therefore, by placing the test specimen TS between two orthogonal polarizers and measuring the change in signal when the terahertz emission electromagnetic wave passes through the test specimen TS along its optical axis (with a 90-degree phase difference), any polarization effects (such as birefringence) can be detected. Birefringence refers to the optical property where light passing through a material experiences two different refractive indices in different directions. One beam of light is polarized perpendicular to the optical axis (experiencing the refractive index of ordinary ray), while the other beam is polarized parallel to the optical axis (experiencing the refractive index of extraordinary ray). When residual stresses exist in the test specimen TS, the residual stresses will cause the material properties in a specific region to change, resulting in birefringence effects when polarized electromagnetic waves pass through. By detecting these birefringence phenomena, the embodiment of the present invention can determine the magnitude and location of residual stresses.

Furthermore, the relationship between the refractive index change measured under different terahertz electromagnetic wave polarizations and stress changes can be expressed as follows:

$$Δ n = S \cdot Δσ \qquad ( Eq . 1 )$$

where Δn represents the refractive index change, S denotes the material photoelastic coefficient, and Δσ corresponds to the stress change. The material's photoelastic coefficient can be determined through measurements, inferring that stress changes may be obtained by assessing refractive index changes. In an embodiment, if direct refractive index measurements are not feasible, refractive index changes may be determined based on alterations in phase caused by material stress. This relationship is given by:

$$Δδ = ( δ1 - δ2 ) = ( 2 π fd ) \cdot Δ n / c \qquad ( Eq . 2 )$$

where Δδ represents the phase change, f denotes the frequency, d represents the material thickness, and c corresponds to the speed of light in a vacuum.

Therefore, from the above analysis, it can be inferred that by detecting changes in the material's photoelastic coefficient and refractive index of the test specimen TS, information about stress variations can be obtained (Eq. 1). If direct measurement of the refractive index change is not feasible, the refractive index change may be determined based on phase change and material thickness (Eq. 2). In this scenario, when placing the test specimen TS in the residual stress detection system 1, the positions or angles of the first polarizer 16 and the second polarizer 18 may be adjusted (e.g., through rotation) to alter the polarization of the electromagnetic waves relative to the optical axis, to allow the terahertz emission electromagnetic wave to penetrate the test specimen TS along its optical axis, and detect the terahertz reception electromagnetic waves at a 90-degree angle to the optical axis. Accordingly, variations in electric field intensity and electric field phase may be detected, so as to determine the magnitude and distribution of residual stress within the test specimen TS.

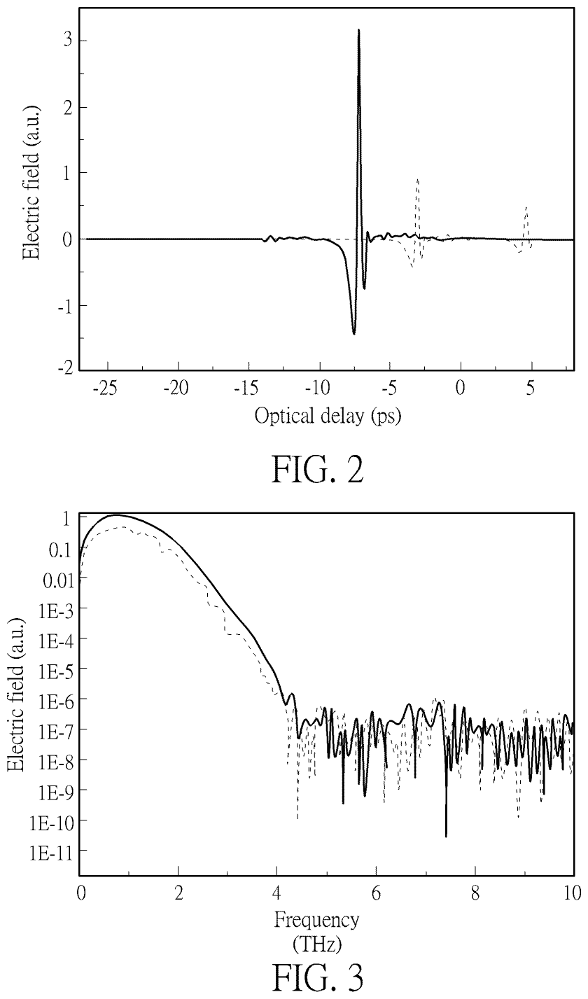

In detail, the detection device 14 may compare the signals obtained from the terahertz emission electromagnetic wave detecting air with the signals obtained from the terahertz emission electromagnetic wave detecting the test specimen TS, and analyze both the time-domain and frequency-domain optical spectra to measure characteristic signals. For example, refer to FIG. 2 and FIG. 3. FIG. 2 and FIG. 3 are schematic diagrams of time-domain and frequency-domain optical spectra detected by the terahertz emission electromagnetic waves. In FIG. 2, the solid line represents the electric field versus the optical delay when the terahertz emission electromagnetic wave detects air (without the test specimen TS) in the time-domain optical spectrum, and the dashed line represents the electric field versus the optical delay when the terahertz emission electromagnetic wave detects the test specimen TS in the time-domain optical spectrum. In FIG. 3, the solid line represents the electric field versus the frequency when the terahertz emission electromagnetic wave detects air (without the test specimen TS) in the frequency-domain optical spectrum, and the dashed line represents the electric field versus the frequency when the terahertz emission electromagnetic wave detects the test specimen TS in the frequency-domain optical spectrum. By analyzing the time-domain and frequency-domain optical spectra, the detection device 14 may measure characteristic signals, to determine coefficients or parameters such as the thickness, interface geometry, optical coefficients, and electrical coefficients of the test specimen TS, and may also analyze residual stresses and identify defects caused by residual stresses or provide a reference for determining the defects. The defects may include dislocations, deformation, changes in molecular chain arrangement, or variations in impurity proportions. Specifically, the detection device 14 measures a transient electric field of each terahertz reception electromagnetic wave in the time domain to obtain electric field intensity, phase, and frequency information of the transient electric field, and measures a spectral electric field between terahertz reception electromagnetic waves in the frequency domain to obtain electric field amplitude and phase information of the spectral electric field. That is, the characteristic signals measured by the detection device 14 may comprise the intensity, the phase and the frequency of the transient electric field of each terahertz reception electromagnetic wave in the time domain, as well as the amplitude and the phase of the spectral electric field in the frequency domain. Since the characteristic signals (the intensity and the phase of the transient electric field, the amplitude and the phase of the spectral electric field) provide sensitivity to material properties, by applying transformations (e.g., Fourier transforms), the detection device 14 may directly measure dielectric constants of the material and calculate optical coefficients thereof (such as a photoelastic coefficient, an absorptance, a refractive index, a reflectivity, and a transmittance), electrical coefficients (such as phase change, conductivity, resistivity, doping concentration, dielectric coefficient, and charge carrier mobility) as well as structural properties. Additionally, the detection device 14 may measure the time of flight for each of the terahertz reception electromagnetic waves and analyze the time of flight to determine the thickness and interface geometry of the test specimen TS.

Therefore, by comparing the signals of the terahertz emission electromagnetic wave detecting air with the signals of the terahertz emission electromagnetic wave detecting the test specimen TS, the detection device 14 can measure the characteristic signals related to the test specimen TS, so as to determine a plurality of characteristics of the test specimen TS. The characteristic signals may include the electric field intensity, electric field phase and electric field frequency of the time-domain electric field for each terahertz reception electromagnetic wave, and/or the electric field amplitude and electric field phase of the spectral electric field between the terahertz reception electromagnetic waves. The plurality of characteristics may include the thickness of the test specimen TS, interface geometry, optical coefficients (such as a photoelastic coefficient, an absorptance, a refractive index, a reflectivity, and a transmittance), and electrical coefficients (phase change, conductivity, resistivity, dopant concentration, dielectric constant, and charge carrier mobility). Accordingly, the detection device 14 may further determine whether the test specimen TS has residual stress, the magnitude and distribution of residual stress, and whether any defects are caused by residual stress or provide a basis for defect assessment.

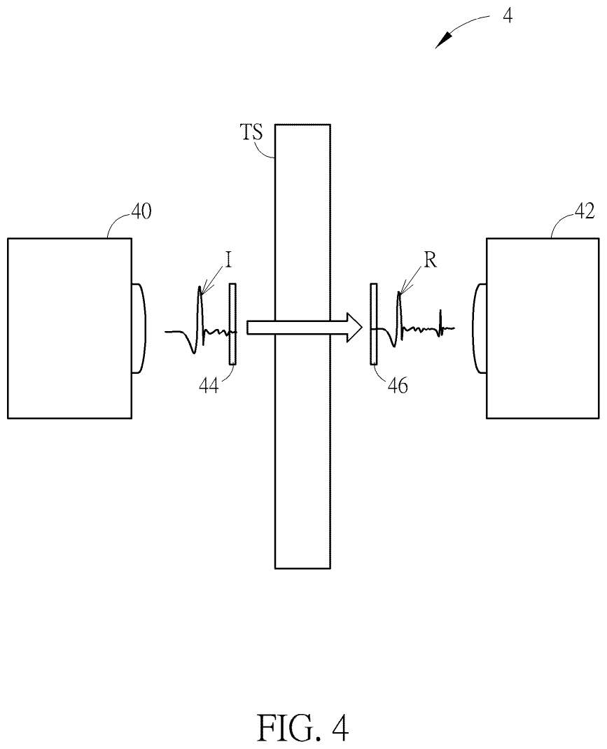

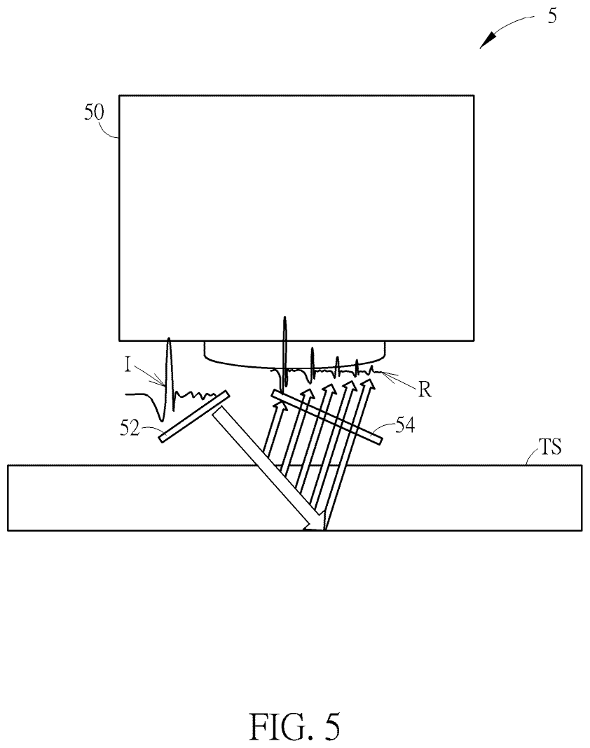

Please note that in FIG. 1, the residual stress detection system 1 is represented by functional blocks as essential components of the embodiment of the present invention. However, when implementing the residual stress detection system 1, those skilled in the art may design or select an appropriate architecture based on practical requirements. For example, refer to FIG. 4 and FIG. 5, which are respectively schematic diagrams of residual stress detection systems 4 and 5 according to embodiments of the present invention. The residual stress detection systems 4 and 5 are derived from the residual stress detection system 1 and adopt transmission and reflection-based terahertz electromagnetic wave detection architectures. For simplicity, FIG. 4 and FIG. 5 omit the specific position of the detection device 14, which can be inferred by those skilled in the art from FIG. 1. Specifically, the residual stress detection system 4 uses a terahertz electromagnetic wave generator 40 to generate the terahertz emission electromagnetic wave I, which is then incident on a test specimen TS through a first polarizer 44, and uses a terahertz electromagnetic wave receiver 42 to detect the terahertz reception electromagnetic waves R transmitted through the test specimen TS via a second polarizer 46. The second polarizer 46 is oriented 90 degrees apart from the optical axis to detect the terahertz reception electromagnetic waves R transmitted through the test specimen TS. The first polarizer 44 and the second polarizer 46 may be composition of linear polarization or elliptical polarization, and both the first polarizer 44 and the second polarizer 46 may be adjusted in position or angle (e.g., by rotation) to allow the terahertz emission electromagnetic wave I to pass through the test specimen TS along its optical axis, while the terahertz electromagnetic wave receiver 42 is oriented 90 degrees apart from the optical axis to detect the terahertz reception electromagnetic waves R. Furthermore, the relative position or angle between the first polarizer 44 and the second polarizer 46 may be preferably adjusted (e.g., by rotation) to ensure maximum variation in the characteristic signals, particularly the electric field intensity and electric field phase within the characteristic signals.

On the other hand, the residual stress detection system 5 adopts the reflection-based detection architecture, wherein a terahertz electromagnetic wave generator and receiver 50 integrates both emission and reception functions. In other words, the terahertz electromagnetic wave generator and receiver 50 generates the terahertz emission electromagnetic wave I, which is directed at the test specimen TS via a first polarizer 52, and detects the terahertz reception electromagnetic waves R reflected by the test specimen TS via a second polarizer 54 after the terahertz emission electromagnetic wave I is incident on the test specimen TS. The first polarizer 52 and the second polarizer 54 may be composition of linear or elliptical polarization and may be adjusted in position or angle (e. g., through rotation), to ensure that the terahertz emission electromagnetic wave I emitted by the terahertz electromagnetic wave generator and receiver 50 enters the test specimen TS along its optical axis, while the terahertz reception electromagnetic waves R are detected at a 90-degree angle to the optical axis. Preferably, the relative position or angle of the first polarizer 52 and the second polarizer 54 may be adjusted to maximize the variation in characteristic signals, particularly the electric field intensity and electric field phase within those signals.

In addition, the operation of the residual stress detection systems 4 and 5 may be referenced from the previously described operation of the residual stress detection system 1. Specifically, the detection device (not shown in FIG. 4 and FIG. 5) analyzes the time-domain and frequency-domain optical spectra of the terahertz emission electromagnetic wave I (without passing through the test specimen TS) and the terahertz reception electromagnetic waves R (after passing through the test specimen TS), to measure a plurality of characteristic signals and determine coefficients or properties such as the thickness, interface geometry, optical coefficient, and electrical coefficient of the test specimen TS. Accordingly, the detection device 14 may use the previously mentioned Eq. 1 and Eq. 2 to assess the residual stress, the magnitude and distribution of the residual stress in the test specimen TS, and whether any defects are caused by residual stress or provide a basis for defect assessment.

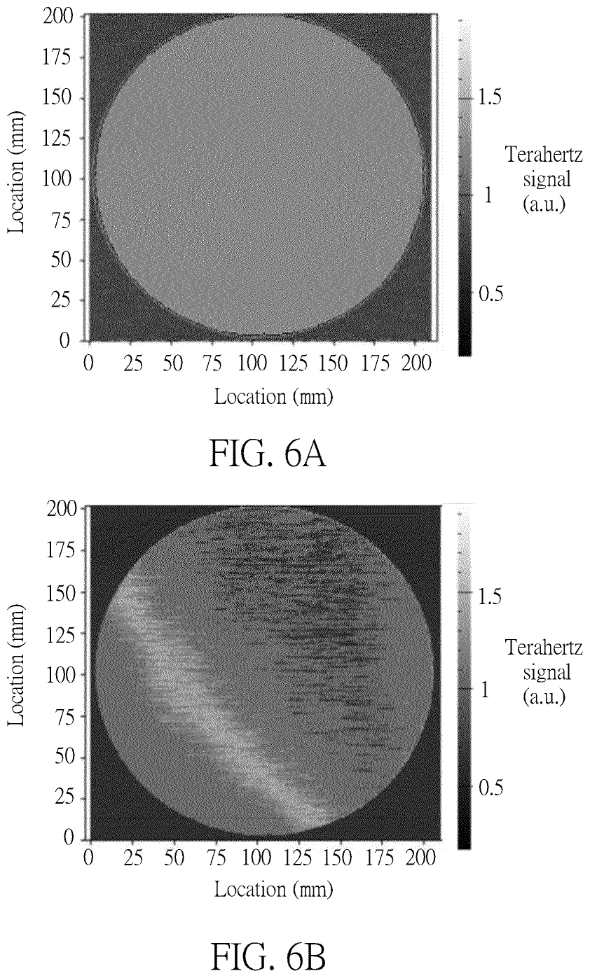

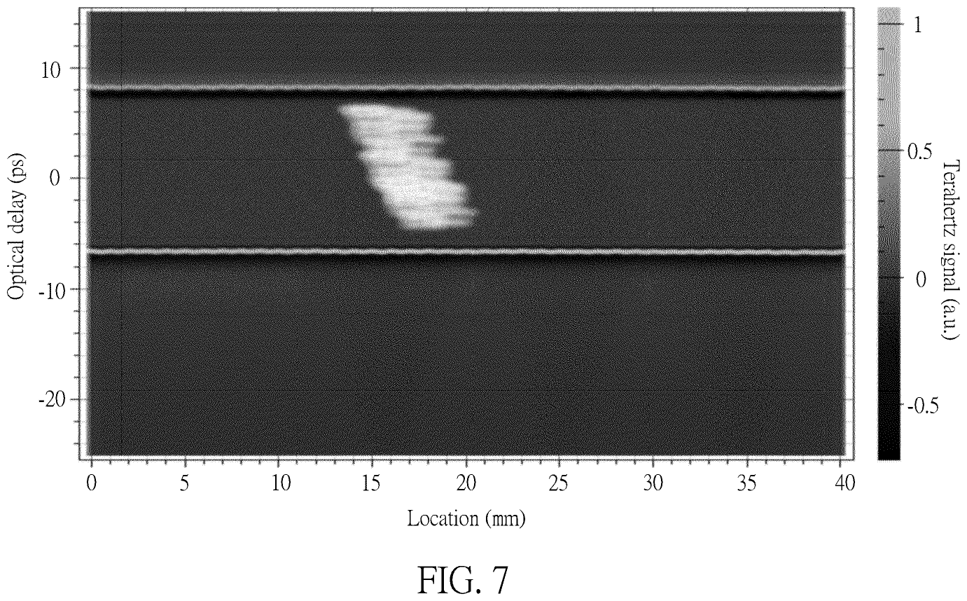

Furthermore, the embodiment of the present invention is applicable for detecting various test specimens TS, including one or more of compounds, insulators, semiconductors, or metals. For instance, if the test specimen TS is a wafer, material thereof may be selected from silicon (Si), silicon carbide (SiC), (gallium arsenide (GaAs), gallium nitride (GaN), aluminum nitride (AlN), gallium oxide (Ga2O3), and others. Additionally, the detection region in the embodiment of the present invention may be a specific point, where single-point measurements yield results similar to those shown in FIG. 2 and FIG. 3. Alternatively, the detection region may cover a specific area, achieved through scanning using a movable detector or sample stage. The detection process may also involve multiple stages, such as examining the front and then the sides. For example, FIG. 6A and FIG. 6B illustrate the C-Scan detection of a wafer by the residual stress detection system 5. In this context, C-Scan represents a planar scan of the wafer. FIG. 6A shows the surface image of the wafer, while FIG. 6B displays the residual stress image detected by the residual stress detection system 5. From FIG. 6B, it is evident that there is residual stress within the wafer. Consequently, further B-Scan detection may be performed on the same wafer, resulting in the detection result shown in FIG. 7. B-Scan represents cross-sectional scanning, and FIG. 7 provides insight into the distribution and magnitude of the internal residual stress. Therefore, by observing FIG. 6A, FIG. 6B, and FIG. 7, those skilled in the art may determine the presence of residual stress and the distribution and magnitude of residual stress. Notably, FIG. 7 reveals that the residual stress exists within the wafer, which cannot be detected using traditional non-destructive microscopy techniques. In other words, the detection results from the residual stress detection system 5 not only indicate the presence of residual stress but also allow for the assessment of internal residual stress. This information aids inspectors in identifying defective products and assists researchers in understanding the causes of defects.

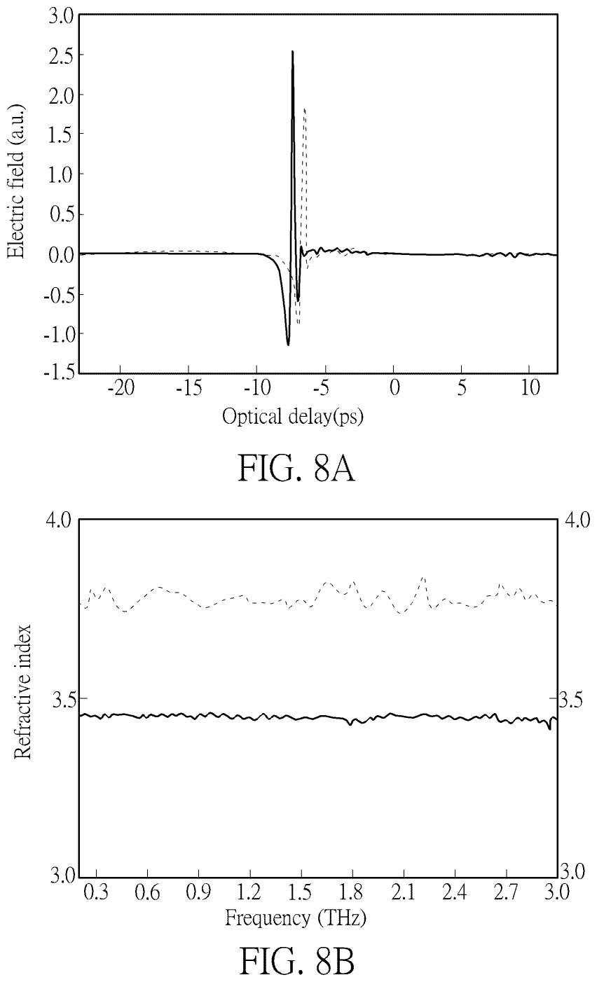

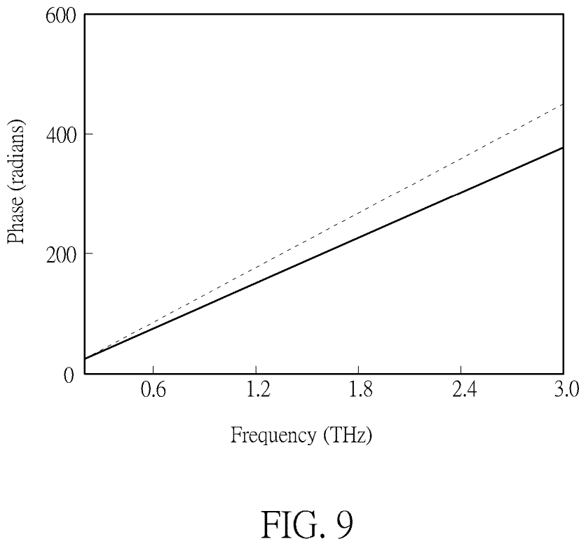

Please note that FIG. 6A, FIG. 6B, and FIG. 7 illustrate possible scenarios for residual stress detection in the embodiment of the present invention, and prior to obtaining these results, information related to refractive index changes or phase changes must be derived based on Eq. 1 and Eq. 2, which should be well known in the art. For instance, FIG. 8A and FIG. 8B depict schematic diagrams of the residual stress detection systems 1, 4, and 5 detecting the electric field and refractive index of the test specimen TS. In FIG. 8A, the solid line represents electric field measurements in stress-free regions, while the dashed line represents measurements in regions with residual stress. Similarly, FIG. 8B shows refractive index measurements, with the solid line indicating stress-free areas and the dashed line indicating regions with residual stress. Furthermore, FIG. 9 is a schematic diagram of phase detection for the test specimen TS using the residual stress detection systems 1, 4, and 5. Therefore, based on the information from FIG. 8A, FIG. 8B, and FIG. 9, those skilled in the art may assess the magnitude and distribution of residual stress according to the aforementioned Eq. 1 and Eq. 2.

Furthermore, the residual stress detection systems 1, 4, and 5 are embodiments of the present invention, and those skilled in the art may make modifications accordingly. For instance, the residual stress detection systems 1, 4, and 5 utilize terahertz electromagnetic wave detection architectures, and may be appropriately integrated with other systems that also employ terahertz electromagnetic waves. For example, the applicant has disclosed a composite structure detection method and system in U.S. patent application Ser. No. 18/813,045, as well as a semiconductor wafer inspection method and the corresponding detection device in Taiwan Patent No. 1788105, which may be applied to the present invention with appropriate adjustments.

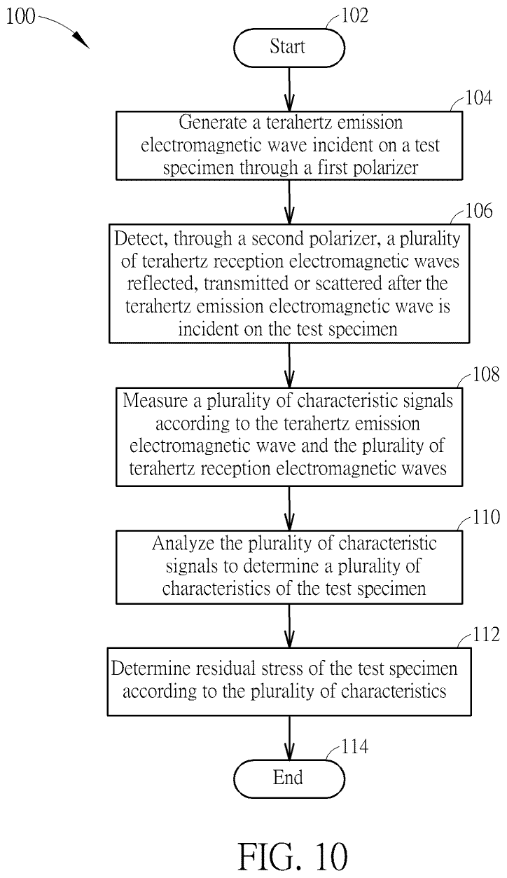

The operations of the residual stress detection systems 1, 4, and 5 mentioned above can be summarized as a residual stress detection process 100, as shown in FIG. 10. The residual stress detection process 100 is used to detect residual stress and includes the following steps:

Step 102: Start.

Step 104: Generate a terahertz emission electromagnetic wave incident on a test specimen through a first polarizer.

Step 106: Detect, through a second polarizer, a plurality of terahertz reception electromagnetic waves reflected, transmitted or scattered after the terahertz emission electromagnetic wave is incident on the test specimen.

Step 108: Measure a plurality of characteristic signals according to the terahertz emission electromagnetic wave and the plurality of terahertz reception electromagnetic waves.

Step 110: Analyze the plurality of characteristic signals to determine a plurality of characteristics of the test specimen.

Step 112: Determine residual stress of the test specimen according to the plurality of characteristics.

Step 114: End.

For detailed operation and variations of the residual stress detection process 100, please refer to the above description, which is not repeated hereinafter.

In the prior art, non-destructive stress measurement techniques can only measure surface or shallow-depth residual stresses of the test specimen, and cannot assess residual stresses deep within the test specimen. In contrast, the present invention utilizes polarized measurement techniques, measures a plurality of characteristic signals based on terahertz emission electromagnetic waves and a plurality of terahertz reception electromagnetic waves, and analyzes the characteristic signals, to determine the magnitude and distribution of residual stresses. Terahertz electromagnetic waves have penetration capabilities for various materials and structures, allowing for the detection of optical coefficients, electrical properties, layer thickness, and structural defects, and can be applied to different materials and structures, or utilized for process inspections, semi-finished or finished product testing, enabling non-contact and non-destructive residual stress assessment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A residual stress detection method, comprising:
generating a terahertz emission electromagnetic wave, and emitting the terahertz emission electromagnetic wave to a test specimen through a first polarizer;
detecting, through a second polarizer, a plurality of terahertz reception electromagnetic waves reflected, transmitted or scattered after the terahertz emission electromagnetic wave is incident on the test specimen;
measuring a plurality of characteristic signals according to the terahertz emission electromagnetic wave and the plurality of terahertz reception electromagnetic waves;
analyzing the plurality of characteristic signals to determine a plurality of characteristics of the test specimen; and
determining residual stress of the test specimen according to the plurality of characteristics.

2. The residual stress detection method of claim 1, wherein a frequency of the terahertz emission electromagnetic wave is between 1011 Hz and 1013 Hz.

3. The residual stress detection method of claim 1, wherein the plurality of characteristic signals comprise an electric field intensity, an electric field phase and an electric field frequency of each of the plurality of terahertz reception electromagnetic waves.

4. The residual stress detection method of claim 3, wherein the plurality of characteristic signals further comprise at least one spectral electric field between the plurality of terahertz reception electromagnetic waves, and each spectral electric field comprises an electric field amplitude and an electric field phase.

5. The residual stress detection method of claim 1, wherein the plurality of characteristics comprise at least one of a thickness, an interface geometry, an optical coefficient and an electrical coefficient of the test specimen.

6. The residual stress detection method of claim 5, wherein the electrical coefficient is at least one of a phase change, a conductivity, a resistivity, a doping concentration, dielectric constant and a charge carrier mobility, and the optical coefficient is at least one of a photoelastic coefficient, an absorptance, a refractive index, a reflectivity, and a transmittance.

7. The residual stress detection method of claim 6, wherein the step of determining the residual stress of the test specimen according to the plurality of characteristics comprises determining residual stress variation of the test specimen according to a change of the refractive index and the photoelastic coefficient.

8. The residual stress detection method of claim 7, further comprising determining the change of the refractive index according to the phase change and the thickness of the test specimen.

9. The residual stress detection method of claim 1, further determining at least a defect of the test specimen according to the plurality of characteristics.

10. The residual stress detection method of claim 9, wherein the at least a defect is at least one of a dislocation, a deformation, a change in molecular chain arrangement, and a variation in impurity proportions.

11. The residual stress detection method of claim 1, further comprising adjusting the first polarizer and the second polarizer to allow the terahertz emission electromagnetic wave to pass through the test specimen along an optical axis, and detect the plurality of terahertz reception electromagnetic waves at a 90-degree angle apart from the optical axis.

12. The residual stress detection method of claim 1, further comprising adjusting the first polarizer and the second polarizer to have a maximum variation in the plurality of characteristic signals.

13. The residual stress detection method of claim 1, wherein the first polarizer and the second polarizer are composition of linear polarization or elliptical polarization.

14. A residual stress detection system, comprising:
a first polarizer, positioned in front of a test specimen;
a second polarizer, positioned behind the test specimen;
a terahertz electromagnetic wave generator, positioned in front of the first polarizer, configured to generate a terahertz emission electromagnetic wave, and emit the terahertz emission electromagnetic wave to a test specimen through the first polarizer;
a terahertz electromagnetic wave receiver, positioned behind the second polarizer, configured to detect, through the second polarizer, a plurality of terahertz reception electromagnetic waves reflected, transmitted or scattered after the terahertz emission electromagnetic wave is incident on the test specimen; and
a detection device, coupled to the terahertz electromagnetic wave generator and the terahertz electromagnetic wave receiver, configured to measure a plurality of characteristic signals according to the terahertz emission electromagnetic wave and the plurality of terahertz reception electromagnetic waves, analyze the plurality of characteristic signals to determine a plurality of characteristics of the test specimen, and determine residual stress of the test specimen according to the plurality of characteristics.

15. The residual stress detection system of claim 14, wherein a frequency of the terahertz emission electromagnetic wave is between 1011 Hz and 1013 Hz.

16. The residual stress detection system of claim 14, wherein the plurality of characteristic signals comprise an electric field intensity, an electric field phase and an electric field frequency of each of the plurality of terahertz reception electromagnetic waves.

17. The residual stress detection system of claim 16, wherein the plurality of characteristic signals further comprise at least one spectral electric field between the plurality of terahertz reception electromagnetic waves, and each spectral electric field comprises an electric field amplitude and an electric field phase.

18. The residual stress detection system of claim 14, wherein the plurality of characteristics comprise at least one of a thickness, an interface geometry, an optical coefficient and an electrical coefficient of the test specimen.

19. The residual stress detection system of claim 18, wherein the electrical coefficient is at least one of a phase change, a conductivity, a resistivity, a doping concentration, a dielectric constant and a charge carrier mobility, and the optical coefficient is at least one of a photoelastic coefficient, an absorptance, a refractive index, a reflectivity, and a transmittance.

20. The residual stress detection system of claim 19, wherein the step of determining the residual stress of the test specimen according to the plurality of characteristics comprises determining residual stress variation of the test specimen according to a change of the refractive index and the photoelastic coefficient.

21. The residual stress detection system of claim 20, wherein the detection device is further configured to determine the change of the refractive index according to the phase change and the thickness of the test specimen.

22. The residual stress detection system of claim 14, wherein the detection device is further configured to determine at least a defect of the test specimen according to the plurality of characteristics.

23. The residual stress detection system of claim 22, wherein the at least a defect is at least one of a dislocation, a deformation, a change in molecular chain arrangement, and a variation in impurity proportions.

24. The residual stress detection system of claim 14, wherein the first polarizer and the second polarizer are capable of being adjusted to allow the terahertz emission electromagnetic wave to pass through the test specimen along an optical axis, and detect the plurality of terahertz reception electromagnetic waves at a 90-degree angle apart from the optical axis.

25. The residual stress detection system of claim 14 wherein the first polarizer and the second polarizer are capable of being adjusted to have a maximum variation in the plurality of characteristic signals.

26. The residual stress detection system of claim 14, wherein the first polarizer and the second polarizer are composition of linear polarization or elliptical polarization.
